(19) United States
(12) Patent Application Publication
(10) Pub. No.: US 2020/0116620 A1
(43) Pub. Date: Apr. 16, 2020

(54) A METHOD FOR MEASURING DISINTEGRATION OF A FIBROUS PRODUCT

(71) Applicant: Kemira Oyj, Helsinki (FI)

(72) Inventors: Clayton Campbell, Easton, MD (US); Jennifer RISER, Marietta, GA (US); Kristin WITTICH, Decatur, GA (US); Frank ZIMMERMANN, Atlanta, GA (US)

(73) Assignee: Kemira Oyj, Heisinki (FI)

(21) Appl. No.: 16/626,891

(22) PCT Filed: Jun. 28, 2018
(86) PCT No.: PCT/FI2018/050514

§ 371 Date: Dec. 27, 2019

Related U.S. Application Data
(60) Provisional application No. 62/527,242, filed on Jun. 30, 2017.

(30) Foreign Application Priority Data
Jul. 13, 2017 (FI) 20175685

(51) Int. Cl. G01N 15/06; G01N 5/02

(52) U.S. Cl. CPC G01N 15/0618; D21C 5/022; G01N 5/02

(57) ABSTRACT

The present invention provides a method and system for measuring disintegration of a fibrous product. The method comprises disintegration of a sample of the fibrous product in an aqueous solution, optionally promoted by mechanical energy, passing the aqueous solution through a screen to obtain a permeate and retained fraction on the screen, and analyzing at least one parameter from the permeate for example by a gravimetric analysis, an optical analysis, an electrochemical analysis, a volumetric analysis, or combination thereof. Advantages include adjustability, speed, and high correlation with actual flushability or repulpability of the fibrous product, and utility in a process for manufacturing a fibrous sheet exhibiting controlled disintegration, such as a flushable or repulpable fibrous sheet.

### FIELD OF THE INVENTION

The invention relates generally to the field of fibrous products, such as flushable and repulpable fibrous products. More specifically, the invention relates to a method and system for measuring disintegration of a fibrous product. Further, the invention relates to a process for manufacturing a fibrous sheet exhibiting controlled disintegration.

### BACKGROUND

The paper industry is in constant need of fibrous products that are sufficiently strong for their intended use but still capable of disintegrating after being disposed of. Wet strength is a desirable attribute of fibrous products that come into contact with water or moisture during further processing steps or use. Examples of such products include sanitary products such as napkins, paper towels, household tissues, and disposable hospital wear, and also certain paper and board grades to be coated, glued, etc. The integrity or strength of a fibrous product is at least partly due to hydrogen bonding between the fibers. When the product is wetted, water disrupts the hydrogen bonds and lowers the strength of the fibrous product. An untreated cellulosic fiber assemblage will typically lose over 90% of its strength when soaked in water.

For increasing the integrity or strength of fibrous products two primary approaches are available. One approach is to prevent water from reaching and disrupting the hydrogen bonds e.g. by special wet-end and surface treatments, such as sizing or coating. A second approach is to incorporate additives in the fibrous product re-suiting in formation of interfiber bonds which are not broken, commonly referred to as permanent wet strength, or bonds which resist being broken by water, known as temporary wet strength. The second approach is the technique of choice for most fibrous products, involving addition of water-soluble wet strength resins to the pulp before the paper product is formed, or on wet fiber web. So-called permanent wet strength resins, such as polyamidoamine epichlorohydrin, result in fibrous products which, when placed in an aqueous medium retain a substantial portion of their initial wet strength. Some fibrous products such as toilet tissues, etc., are generally disposed of after brief periods of use into septic systems. If a fibrous product intended for, or liable to, being flushed through a municipal waste or into a septic system permanently retains its hydrolysis-resistant strength properties, clogging of the system may occur. Similarly, for fibrous products to be recycled, too high of permanent wet strength is not desired as repulping would require harsh conditions and lots of energy. Flushability or repulpability are the main reasons why manufacturers are increasingly using temporary wet strength additives providing wet strength that is sufficient for the intended use, but which then decays upon contact with water. Decay of the wet strength facilitates easier disintegration during repulping or when flushed through a municipal waste or into a septic system. Approaches for providing fibrous products having good initial wet strength which decays significantly over time are being developed continuously.

Flushability is a major issue for many fibrous products such as nonwovens. Especially wipes are commonly clogging piping and pumps in municipal wastewater systems. INDA, International Association of the Nonwoven Fabrics Industry, has been working with wipes manufacturers, wastewater treatment facilities and local government officials to address this growing issue, and has provided a slosh box disintegration test for assessing the potential for a product to disintegrate when it is subjected to mechanical agitation in water or wastewater. Development of new technologies and fiber sources is ongoing to provide fibrous products that are flushable, but still meet the high quality requirements of the intended use.

Not all fibrous products marked as flushable are truly dispersible because they do not disperse well in all conditions that the products encounter in toilet and septic systems. Many of the fibrous products marked as flushable are flushable only based on their small size, i.e. they are small enough to pass through plumbing systems without clogging. However they do not necessarily break down into smaller pieces or fiber clusters at all, or only to minor extent. For example almost all products that are claimed as flushable may pass the INDA flushability guidelines and even the slosh box disintegration test, but only few of them are truly dispersible because they do not disperse adequately to pass through smaller pipes and other types of restrictions in sewage treatment systems. As a result, even though such fibrous products pass through the piping systems immediately after flushing, they may plug up the sewage systems and the effluent clarifiers controlled by the city/municipal systems.

A further drawback of INDA slosh box disintegration test is that it has multiple steps, and requires several hours, even a day, to obtain the results, and the result indicates only pass/fail information giving little to no information on e.g. dispersion into individual fibers, fines, or fiber bundles, or the rate of disintegration.

Despite the increasing need, very few techniques are available for measuring or verifying the rate of disintegration of fibrous products. Thus there is a need for methods for measuring disintegration of a fibrous product that are reliable and simple, do not require sophisticated or expensive equipment, and are capable of providing a quick pass/fail indication of dispersibility, quantitative indication of disintegration, and/or a rate of disintegration.

### SUMMARY

The object of the present invention is to minimize or even eliminate the disadvantages existing in the prior art.

Another object of the present invention is to provide a reliable method for measuring disintegration of a fibrous product.

Yet another object of the present invention is to provide a system for measuring the disintegration of fibrous products.

A further object of the present invention is to provide a process for manufacturing a fibrous sheet exhibiting controlled disintegration, using the method for measuring disintegration of the fibrous product according to the invention.

These objectives are attained with the invention having the characteristics presented in the characterizing parts of the appended claims.

Some preferred embodiments of the invention are presented in the dependent claims.

The present invention facilitates a reliable assessment of the capability of disintegration, and more specifically the dispersibility, of fibrous products in aqueous medium. Additionally, using some embodiments of the invention it is possible to evaluate whether a fibrous product disintegrates into fragments in macroscale, i.e. breaking into relatively large fragments, or in microscale, i.e. dispersing into fiber bundles or individual fibers, thereby providing improved assessment and understanding of disintegration of fibrous products. This is especially useful when developing or manufacturing truly flushable and repulpable fibrous products, which will provide major savings in terms of reduced toilet, piping, holding or septic tank clogging, reduced operational malfunctions, higher yields in repulping of recycled paper and broke, and reduced environmental pollution (e.g. land disposal).

Further advantages of the present invention are described and exemplified in the following Figures and Detailed Description. The embodiments and advantages mentioned in this specification relate, where applicable, to the method, system, process and fibrous sheet according to the present invention, even though it is not always specifically mentioned.

### BRIEF DESCRIPTION OF THE FIGURES

The accompanying drawings, which are included to provide a further understanding of the present invention and constitute a part of this specification, illustrate some embodiments of the present invention and together with the description help to explain the principles of the present invention. In the drawings:

FIG. 1 shows disintegration-% and turbidity of screened permeate for a towel sample as a function of static mixing time.

FIG. 2 shows disintegration-% and turbidity of screened permeate for a towel sample as a function of static mixing speed.

FIG. 3 shows disintegration-% and turbidity of screened permeate for tissue and towel samples comparing a rotating wheel and an oscillating table (shaker).

FIG. 4 shows disintegration-% and turbidity of screened permeate for towel samples when using vertical mixing wheel (far left) and an oscillating table (shaker) with increasing static mixing speeds for 30 min (except 60 min for shaker with 400 rpm).

FIG. 5a shows disintegration-% as function of time (h) for a 2-ply bath tissue S3 using 26 rpm on mixer wheel, and Britt jar at 100 rpm while screening through a ¼″ screen, and in parallel using 1/16″ screen, and FIG. 5b shows the same for 2-ply bath tissue S2.

FIG. 6 shows disintegration-% as function of time (h) for four 2-ply bath tissues using 26 rpm on mixer wheel, and no mixing while screening through a ½″ screen. Effect of permanent or temporary or no wet strength agent is demonstrated.

FIG. 7 shows disintegration-% as function of time (h) for three 2-ply tissues using rpm on mixer wheel, and no mixing while screening through a ¼″ screen.

FIG. 8 is a flow chart illustration of the system according to some embodiments of the present invention.

### DETAILED DESCRIPTION

The inventors surprisingly found that disintegration, found to be related to flushability and repulpability of a fibrous product, may be measured in a reliable manner by the method of the present invention. Additionally it was found that the measuring method may be used for controlling disintegration, e.g. monitoring flushability and repulpability, of fibrous sheets when they are manufactured.

By flushable it is commonly meant that a fibrous product is able to be disposed of through a sanitation device, such as toilet, without clogging or otherwise interfering with the disposal process. The current measure of flushability is set by the 3rd edition of the INDA/EDANA Guidelines for Assessing the Flushability of Disposable Nonwoven Products (A Process for Assessing the Compatibility of Disposable Nonwoven Products with Plumbing and Wastewater Infrastructure (June 2013)). For a product to be deemed flushable it needs to clear toilets and properly maintained drainage pipe systems when the suppliers recommended usage instructions are correctly followed; pass through wastewater conveyance systems and be compatible with wastewater treatment, reuse and disposal systems without causing system blockage, clogging or other operational problems; and be unrecognizable in effluent leaving onsite and municipal wastewater treatment systems and in digested sludge from wastewater treatment plants that are applied to soil.

By disintegration it is meant a process, in which a fibrous product weakens, loses its integrity and breaks into smaller parts. Typically it is operationally defined by mass loss of the product after exposure to specific environmental conditions. Disintegration may be the result of dissolution of soluble components, chemical or biological degradation of constituents in the product, physical forces that break the product into smaller products or a combination of the above.

By dispersion it is meant a disintegration process that is characterized by a material breaking into fine pieces that separate from each other and distribute themselves more or less evenly in water. Dispersibility of a fibrous product may be seen as disintegration of the fibrous product into fiber bundles and/or individual fibers and fines.

Generally a product is considered dispersible if it passes a Slosh Box Disintegration Test set forth in INDA FG502. While both disintegration and dispersibility refer to the breakdown of a product, disintegration is a more inclusive term involving both macro- and microscale disintegration and breakdown of a product, whereas dispersibility refers to the physical separation of the product into fine pieces.

Therefor any method that does not directly measure the dispersed fraction may be insufficient for assessing true dispersibility of the fibrous product.

Typical methods for measuring disintegration of a fibrous product comprise:

(a) immersing at least one sample of a fibrous product, the sample having initial dry weight mᵢ, in an excess of aqueous solution in a receptacle at time point to for initiating disintegration of the sample(s),
(b) optionally subjecting the immersed sample(s) from step (a) to mechanical energy for promoting the disintegration of the sample(s) into a disintegrated sample(s),
(c) after a first time period at time point ti passing aqueous solution containing a first disintegrated sample of the fibrous product (i.e. sample from step (a) or (b)) through a first screen to obtain a permeate containing a passed fraction of the disintegrated sample, and a retained fraction of the disintegrated sample on the first screen, and optionally continuing immersion of any further immersed sample(s),
(d) subjecting the permeate containing the passed fraction of the disintegrated sample from step (c) to an analysis of at least one parameter for obtaining at least one characterizing value, and optionally normalizing the characterizing value by dividing by a basis weight, caliper, bulk, or density of the fibrous product, or by the initial sample dry weight mᵢ.

Optionally the obtained characterizing value is further compared to a predetermined reference value thereby determining the difference between the obtained characterizing value and the predetermined reference value. Said predetermined reference value may correspond for example to a known property such as disintegration-%.

The method of the present invention facilitates determining a characterizing value correlating e.g. with the level of disintegration, or a time series of characterizing values representing e.g. rate of disintegration of the fibrous product. When disintegration rate or disintegration profile is to be measured, it is essential to immerse all samples at time point to and to continue the immersion of samples until separation of fractions described as step (c) on desired time points t₁, t₂ . . . tₙ is performed. As any bigger solids are collected on the screen, the accuracy of the analysis of the permeate may be improved, and error margin decreased, especially when using an optical analysis. Additionally it may be possible to evaluate whether the fibrous product disintegrates into fragments only in macroscale, i.e. breaking into relatively large fragments remaining on the screen, or whether the disintegration into fragments also or even predominantly involves dispersion into fiber bundles or individual fibers and fines passing through the screen to the permeate. This kind of assessment is highly valuable for obtaining improved assessment and understanding of flushability or repulpability of the fibrous product.

In some embodiment the level of disintegration or a time series of characterizing values representing e.g. rate of disintegration of the fibrous product is compared with respective values obtained from other samples (such as tissues of different quality) or samples obtained using different process parameters. In some embodiment the characterizing value to a predetermined reference value or said rate of disintegration for the fibrous product is compared with respective values obtained from other samples or samples obtained using different process parameters. These allow identification and modification the process (parameters of the process) to obtain enhanced dispersibility of the fibrous product. In some embodiments the analysis of at least one parameter comprises a gravimetric analysis, an optical analysis, an electrochemical analysis, a volumetric analysis, or any combination thereof. Preferably the analysis comprises at least gravimetric analysis due to its accuracy and being quantitative by showing actual degree of disintegration.

In some embodiments the gravimetric analysis comprises:

(e) filtering the permeate from step (c) through a filtration device having dry weight m₁ to obtain a filtrate and the passed fraction of the disintegrated sample on the filtration device,
(f) drying and weighing the filtration device and the passed fraction of the disintegrated sample to obtain weight m₂, and obtaining a disintegration-% of the fibrous product by calculating with equation:

$$Disintegration - \% = \frac{( {m}_{2} - {m}_{1} )}{{m}_{i}} ⋆ 100 \% ,$$

and optionally normalizing the disintegration-% by dividing by a basis weight, caliper, bulk, or density of the fibrous product, or by the initial sample dry weight mᵢ.

In some embodiments the characterizing value or the disintegration-% is normalized by dividing by a basis weight, caliper, bulk or density of the fibrous product, especially when the fibrous product is a fibrous sheet, as this may improve the accuracy of the measuring method. This is because basis weight, caliper (thickness), bulk (specific volume) and density (specific weight) involve information relating to the volume of the fibrous product, which has an impact on the disintegration.

Some particular methods for measuring disintegration of a fibrous product according to the present invention comprise:

(a) immersing at least one sample of a fibrous product, the sample having initial dry weight mᵢ, in an excess of aqueous solution in a receptacle at time point to for initiating disintegration of the sample(s),
(b) optionally subjecting the immersed sample(s) to mechanical energy for promoting disintegration of the sample(s) into disintegrated sample(s),
(c) after a first time period at time point t₁ passing aqueous solution containing a first disintegrated sample of the fibrous product through a first screen to obtain a permeate containing a passed fraction of the disintegrated sample, and a retained fraction of the disintegrated sample on the first screen, and optionally continuing immersion of any further immersed sample(s),
(d) subjecting the permeate containing the passed fraction of the disintegrated sample from step (c) to a gravimetric analysis for obtaining a disintegration-% of the fibrous product, wherein the gravimetric analysis comprises
(e) filtering the permeate through a filtration device having dry weight m₁ to obtain a filtrate and the passed fraction of the disintegrated sample on the filtration device,
(f) drying and weighing the filtration device and the passed fraction of the disintegrated sample to obtain weight m₂, and obtaining a disintegration-% of the fibrous product by calculating with equation:

$$Disintegration - \% = \frac{( {m}_{2} - {m}_{1} )}{{m}_{i}} ⋆ 100 \% ,$$

and optionally normalizing the disintegration-% by dividing by a basis weight, caliper, bulk, or density of the fibrous product, or by the initial sample dry weight mᵢ.

In some embodiments non-gravimetric analyses may be used in addition to or instead of the gravimetric analysis, as these may be quicker and less laborious, for example involving use of just a single automated detector. These analyses may give sufficiently accurate information about disintegration or dispersibility, especially of pass/fail type, or even quantitative information, particularly when a calibration curve has been prepared for example by plotting the instrumental response versus disintegration-%, optionally normalized. Preferably said non-gravimetric analyses are used in addition of the gravimetric analysis.

Some other methods for measuring disintegration of a fibrous product according to the present invention comprise:

(a) immersing at least one sample of a fibrous product, the sample having initial dry weight mᵢ, in an excess of aqueous solution in a receptacle at time point to for initiating disintegration of the sample(s),
(b) optionally subjecting the immersed sample(s) to mechanical energy for promoting disintegration of the sample(s) into disintegrated sample(s),
(c) after a first time period at time point ti passing aqueous solution containing a first disintegrated sample of the fibrous product through a first screen to obtain a permeate containing a passed fraction of the disintegrated sample, and a retained fraction of the disintegrated sample on the first screen, and optionally continuing immersion of any further immersed sample(s),
(d) subjecting the permeate containing the passed fraction of the disintegrated sample from step (c) to at least one non-gravimetric analysis, preferably to an optical analysis, an electrochemical analysis, a volumetric analysis, or any combination thereof, for obtaining at least one characterizing value for the fibrous product, more preferably subjecting the permeate to an optical analysis for obtaining a turbidity of the permeate,
and comparing the obtained characterizing value to a predetermined reference value corresponding for example to a known property such as disintegration-%, thereby determining difference between the obtained characterizing value and the predetermined reference value.

The fibrous product may be any fibrous product, or a piece thereof, comprising (as a coherent assembly) cellulosic fibers, non-cellulosic polymeric fibers, or any combinations thereof. In some embodiments the fibrous product comprises or consists essentially of cellulosic fibres. In other words the fibrous product may comprise at least 80% (w/w), at least 90% (w/w), at least 95% (w/w), at least 98% (w/w), 99% (w/w), and even 100% (w/w) of cellulosic fibers, based on dry weight of the fibrous product. Examples of fibrous products include a paper product, a nonwoven, a tampon, a tampon holder, a diaper, a wadding, a pad, a medical dressing, molded product such as transport package or a sponge. Examples of the paper product include tissue, towel, printing paper, writing paper, board, cardboard, fluting, broke, recycled paper, bath tissue etc. Examples of the nonwoven include a hygienic wipe, a household cleaning wipe, a towelette, etc. By cellulosic fibers are meant any cellulosic or lignocellulosic fibers separated e.g. from wood, cotton, flax, hemp, jute, ramie, kenaf, abaca, or sisal, or fibers of regenerated cellulose such as rayon, lyocell, viscose. Typically the cellulosic fibers comprise pulp fibers obtained by chemical pulping such as Kraft pulping or sulphite pulping, mechanical pulping, thermomechanical pulping, chemithermomechanical pulping, or organosolv pulping. The cellulosic fibers may be bleached. In addition to cellulosic fibers, or instead of them, the fibrous products may comprise non-cellulosic polymeric fibers, such as fibers of polyethylene, polypropylene, or polyester, in the form of e.g. single component or bicomponent fibers. In some embodiments the fibrous product may comprise or consists essentially of at least 80% (w/w), at least 90% (w/w), at least 95% (w/w), at least 98% (w/w), 99% (w/w), and even 100% (w/w) of non-cellulosic polymeric fibers, based on dry weight of the fibrous product. Fibrous products may further comprise dry strength resins, wet strength resins, softeners, binders, fillers, colors, ink, or other substances, that may resist or ease disintegration of the fibrous product. In some embodiments the fibrous product comprises at most 10% (w/w), or at most 5% (w/w), or at most 3% (w/w) of additives, based on dry weight of the fibrous product.

In some embodiments, the fibrous product is a fibrous sheet, preferably a paper product or a nonwoven. In some embodiments, the fibrous product is a fibrous web formed in paper or board manufacturing or a residue of it. Said web may contain process water (“wet web”) or be essentially dry. These fibrous products represent the biggest product groups in need of a reliable method and system for measuring disintegration, and for assessing flushability and repulpability of these products. The methods and the system benefit the development of dispersible products such as flushable or repulpable paper products and nonwovens.

Conveniently the fibrous product is cut into similar size pieces or samples for testing and comparison, e.g. 1“×1” or 2″×2″, or 3″×3″, etc. before immersing in an excess of aqueous solution. One sample may comprise two or more subsamples of the fibrous product. Preferably the initial dry weight mᵢ of the sample is determined for at least one additional sample, and used for all samples of the same product batch and of the same size. This is because drying may cause curing or hornification of the sample which may have an effect on the disintegration or dispersibility thereof. The aqueous solution may be any aqueous solution, such as deionized water, but preferably it is tap water to better simulate the actual conditions of flushing. By excess is meant such an amount that is not completely absorbed by the sample of the fibrous product, but covers it, and may allow it to float. The amount of fibrous product (amount of a sample of a fibrous product) may be less than 50% (w/w) of the aqueous solution, such as at most 30% (w/w), or at most 20% (w/w), or at most 10%, or at most 5% (w/w) of the aqueous solution. In some embodiments it may improve accuracy of the measurement, e.g. better simulate flushing conditions, if the amount of the sample of the fibrous product is at most 3% (w/w) or even at most 1% (w/w) of the aqueous solution.

The receptacle may be any vessel or container suitable for receiving the sample of the fibrous product and the aqueous solution, and withstanding the mechanical energy, when applied. It may have any shape and be of any suitable material. Preferably the receptacle is sealable, and may be sealed for example by a cap, lid or cover during any step of the method, especially when mechanical energy is being applied, for preventing spillage. In some embodiments the receptacle comprises built-in elements inside further promoting the disintegration, such as baffles or plates.

The screen may be any suitable screen comprising at least one opening, preferably plurality of openings to avoid slowing down of the screening and clogging of the screen, for example a perforated plate or sieve. The openings may be of any shape. In some embodiments the screen has a mesh size of at most about 1″, but preferably at most about ½″, that passes through loose fiber, fines, fiber bundles and large fragments of the sample, or at most about ¼″ that passes through loose fiber, fines, fiber bundles and small fragments of the sample, or at most about ⅛″ that passes through loose fiber and fines of the sample. For example the screen may have a mesh size in the range of about 0.053″ to about 1″, preferably about 1/16″ to about ½″, or about 1/16″ to about ¼″. The mesh size of about 1″ or about ½″, passing larger fragments through, may in most cases be too large for assessing dispersibility. However, such screens may be useful when evaluating or quantifying how the disintegration of the fibrous product proceeds, especially in embodiments using at least two screens of different mesh sizes. It is thus to be noted that it may be necessary to use larger sample sizes (width/diameter of a solid sample). A suitable sample size (width/diameter): mesh size ratio for example bath tissue may be between 4:1 and 10:1 or between 6:1 and 8:1. Respectively, a sample size (width/diameter of a solid sample) may be between 400% and 1 000% or 600% and 800% of the mesh size. A sample size (width/diameter of a solid sample) may be at least 300%, preferably at least 400%, more preferably at least 500% of the mesh size. Mesh size of at most about ¼″ may be optimal e.g. for assessing flushability of a fibrous product. Mesh size of at most about ⅛″ or even at most about 1/16″ may be optimal e.g. for assessing repulpability of a fibrous product as the yield of individual fibers is important for minimizing amount of reject. As used herein by mesh size is meant the size of a screen opening in inches.

Increased introduction of mechanical energy (e.g. higher rpm) typically enhances the dispersion rate and allows either using smaller mesh sizes and/or shortening the dispersion time. In some embodiments the immersed sample(s) are subjected to mechanical energy for promoting disintegration of the sample(s) into fragments, to better simulate flushing or repulping conditions, and for shortening the time required for carrying out the method. However, fibrous products known to be very easily dispersible may not need subjecting to mechanical energy at all. Suitably the test conditions are in line with the actual use conditions, such as flushing or repulping. In flushing the mechanical energy in typically low and the product should be disintegrated to allow flushing without clogging. In repulping the energy should be sufficient to disintegrate and disperse the application without damaging the fibers and thereby compromising properties of the recycled product to be formed.

In the physical sciences, mechanical energy is the sum of potential energy and kinetic energy. It is the energy associated with the motion and position of an object. Subjecting the immersed sample(s) of the fibrous product to mechanical energy for promoting disintegration of the sample(s) into fragments may be achieved by any device capable of causing motion and/or changing position of the sample(s) immersed in the aqueous solution. Examples of suitable devices include static mixers, dynamic mixers, and sonicators, such as ultrasonicators.

In some embodiments, in step (b) the mechanical energy is generated by static mixing and/or ultrasonication, preferably by static mixing. Both ultrasonication and static mixing provide gentle mixing, avoiding excessive shear forces. In this way, the disintegration test may provide a more reliable indication of flushability of the fibrous product, noting the relatively gentle flow in wastewater systems. Static mixing is preferred as the energy level may be easily adjusted, and it actually turned out to be more efficient in promoting the disintegration, compared to ultrasonication. Furthermore static mixing better mimics the swirling and sloshing motion of a fibrous product flushed through a wastewater piping system.

In some embodiments, static mixing is conducted by subjecting the sample(s) of the fibrous product immersed in the aqueous solution to a rotating and/or oscillating movement. This may be achieved by any suitable means, but preferably by mounting the receptacle(s), e.g. using clamps or other fixing means, to a rotating mixer or to an oscillating plane. The oscillating plane may be arranged for example to tilt from side to side, or to provide horizontal circular or ellipsoidal shaking or oscillation. Preferably the oscillating plane is an oscillating table. The rotating mixer may rotate the receptacle containing the immersed sample horizontally, vertically or inclined. In some embodiments the rotating mixer is a rotating wheel, bottle roller, or tumble blender, preferably a rotating wheel.

The mechanical energy may also be generated by dynamic mixers. Their action, however, may cause such strong shear forces to the fibrous product that the disintegration test provides too optimistic of an impression of the product's ability to disintegrate, such as flushability, noting the relatively gentle flow in wastewater systems. On the other hand, for assessing repulpability of a fibrous product dynamic mixing may be a more suitable option. In some embodiments, in step (b) the mechanical energy is generated by dynamic mixing, for example using an agitator, a blender, or a rotor-stator mixer.

In some embodiments at least one chemical is added to the aqueous solution during step (a) and/or (b). In this way the effect of these chemicals may be assessed on the disintegration characteristics such as disintegration-% or rate when the fibrous product is brought into contact with water, for example if an improved repulping process is being developed, or effect of chemicals in septic tank or toilet flushing water is studied. Also other conditions especially during step (a) and/or (b) may be altered, such as temperature or pressure, for example for assessing their effect on repulping efficiency.

In some embodiments, in step (c) the retained fraction of the disintegrated sample on the first screen is rinsed with rinsing water for flushing any entrapped fines through the screen to the permeate. This may be conducted by rinsing the retained fraction with rinsing water while on the screen. However this may be not efficient for reducing entrapment of fibers and fines as these may still remain inside clumped and folded larger fragments. Preferably the rinsing step is conducted by re-suspending the retained fraction in rinsing water and passing the resuspended retained fraction through the screen. These embodiments may provide improved accuracy as entrapment of fibers and fines by the larger fragments retained on the screen may be minimized. Preferably the rinsing step is conducted at least twice to further improve the accuracy.

In some preferred embodiments in step (c) the aqueous solution containing a first disintegrated sample of the fibrous product is further diluted with water before passing through a first screen. In these embodiments the amount of the sample of the fibrous product may be at most 3% (w/w) or at most 1% (w/w) or even at most 0.1% (w/w) of the aqueous solution including the dilution water. Alternatively or additionally, in some embodiments in step (c) the aqueous solution containing a first disintegrated sample of the fibrous product is passed through a first screen accompanied by a mild agitation to keep the sample fragments uniformly suspended throughout the screening. All these embodiments may provide improved accuracy of the measuring method as the disintegrated fragments including fibers and fines are more uniformly suspended, thereby minimizing entrapment of the fibers and fines by the larger fragments retained on the screen.

In some embodiments any residues of the disintegrated sample of the fibrous product are rinsed from the receptacle with rinsing water and passed through the first screen. In this way the accuracy of these embodiments may be further increased.

In some embodiments, in step (c), passing the aqueous solution containing the first disintegrated sample of the fibrous product through the first screen is facilitated by mixing. The mixing may be conducted by any mixing means, for example by an impeller above the screen, to keep the disintegrated fragments including fibers and fines in movement and thus more uniformly suspended while passing through the screen. A preferred type of equipment for passing the aqueous solution through the first screen facilitated by mixing is a Britt jar equipped with a screen having a suitable mesh size and an impeller. These embodiments may further improve the accuracy of the measuring method as the entrapment of the fibers and fines by the larger fragments may be further minimized.

In some embodiments, at a time point t₂ a second disintegrated sample, and optionally at any further time point tₙ any further disintegrated sample, is subjected to steps (c) to (f), and the obtained disintegration-% values are plotted as a function of time (t₁, t₂ . . . tₙ) to obtain a rate of disintegration for the fibrous product. These embodiments are especially beneficial when it is important to learn the disintegration profile of the fibrous product over time, for example to identify products exhibiting delayed disintegration.

In some embodiments, the methods further comprise for each sample a parallel sample, that in step (c) is passed through a second screen having a mesh size smaller than the mesh size of the first screen to obtain a parallel permeate containing a passed fraction of the disintegrated parallel sample, and a retained fraction of the disintegrated parallel sample on the second screen, followed by step (d) for obtaining a parallel characterizing value. Some of these embodiments may further comprise steps (e) and (f) for obtaining a parallel disintegration-% for the fibrous product. In this way it may be possible to evaluate and quantify how the disintegration of the fibrous product proceeds. For example the characterizing value for the sample, such as disintegration-%, may represent the total disintegration of the fibrous product, including macroscale disintegration, and the parallel characterizing value, such as parallel disintegration-%, may represent just the microscale disintegration into free fibers and fines. In principle plurality of screens of decreasing mesh sizes may also be arranged successively for assessing the same sample.

The disintegration-% may correlate with the actual flushability or repulpability, or the safe disintegration of the fibrous product. This correlation may depend on the type of the fibrous product, and be different for example for a tissue and for a towel. Also, the presence of any chemical additive contributing to wet strength of the fibrous sheet, incorporated to the aqueous suspension or added on the wet fibrous web or on the dried fibrous sheet, may have a remarkable impact on the disintegration-%. As known by a skilled person in the art there are several known factors such as furnish type, process chemistry and temporary wet strength affecting the disintegration properties of a fibrous product. By suitably selecting the analysis method and parameters to be analysed it may be possible to obtain information about such known factors, or to identify new factors, affecting the disintegration properties.

In some embodiments, the permeate containing the passed fraction of the disintegrated sample from step (c) is subjected to an analysis of at least one parameter for obtaining at least one characterizing value, wherein the analysis of at least one parameter comprises an optical analysis, an electrochemical analysis, a volumetric analysis, or any combination thereof. Especially an analysis comprising detection by a detector may provide a quick pass/fail indication of flushability or repulpability, for example when comparing the obtained characterizing value to a predetermined reference value corresponding e.g. to a known disintegration-%. When the analysis comprises one of these analyses, the method may provide further information e.g. about the disintegration mechanism. The parameter may be for example turbidity, particle size, charge density, alkalinity or conductivity. In preferred embodiments, the parameter is turbidity and the analysis is an optical analysis for example conducted with a turbidimeter, a nephelometer, a ratio turbidimeter, a photometer, an ultraviolet-visible spectrophotometer, a laser-based turbidimeter, a reflectometer, a fiber-optic system, or an optical backscatter sensor (OBS), preferably with a ratio turbidimeter. Optical analysis is capable of providing accurate results for a permeate obtained using a screen having a mesh size of at most ⅛″, preferably at most 1/16″, i.e. not containing large fragments. High amounts of recycled fibre material in the fibrous product may provide increased values in the optical analysis, so the optical analysis may be used for recognizing such products. The nephelometer measures directly the intensity of light scattered (usually at 90° to the beam direction) by suspended particles (here fragments of the sample of the fibrous product), the intensity being proportional to the amount of suspended particles in the light path. Nephelometers usually provide better precision and sensitivity than turbidimeters and may be beneficial for solutions of low turbidity containing small particles. The turbidimeter measures the intensity of light after it has passed through the solution and quantifies the amount of transmitted light remaining. Turbidimeters may be beneficial for relatively turbid solutions in which the scattering particles are large in relation to the light wavelength used. A ratio turbidimeter may incorporate measurement systems for light which is side-scattered (usually at 90°), optionally for light which is forward-scattered, and for light which is transmitted, obtaining turbidity value as the ratio of the 90° signal to the transmitted value, or to the sum of forward-scattered and transmitted values. The ratio turbidimeters may be beneficial for strongly and/or variably colored solutions, or for solutions of high turbidity, such as for fibrous product comprising high amounts of recycled fibre material. Ultraviolet-visible spectrophotometer may be used for the optical detection by measuring the absorption of light by suspended particles at a fixed wavelength or full spectrum. OBS monitors solution turbidity through the backscattering of pulsed infrared light emitted from the OBS instrument head. All these optical analyses are easy to conduct, and provide quick and accurate detection. Regardless of the type of optical analysis used, in the following the device for measuring the turbidity using the optical analysis is generally referred to as a turbidity meter.

In some embodiments, a portion of the permeate or the entire permeate containing the passed fraction of the disintegrated sample from step (c) may be routed to an analysis by a detector, such as turbidity meter (e.g., through a measuring flow cell of a turbidity meter) to detect at least one parameter of the aqueous solution or of the dispersed fragments of the disintegrated sample.

In addition to subjecting the permeate containing the passed fraction of the disintegrated sample from step (c) to an analysis, also the retained fraction of the disintegrated sample on the screen may be subjected to an analysis. For example when the permeate is subjected to an analysis providing quick pass/fail indication, the retained fraction may be subjected to a more time-consuming gravimetric analysis.

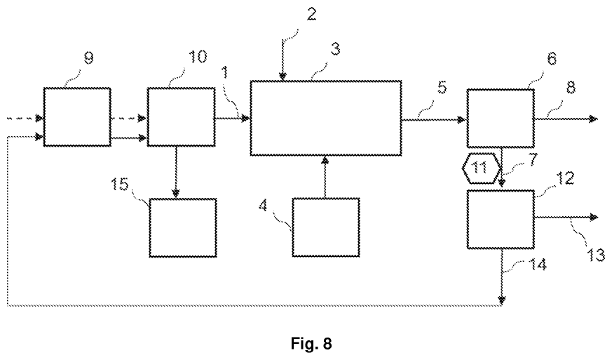

Referring to FIG. 8, a typical system for measuring disintegration of a fibrous product comprises:

at least one receptacle 3 configured to receive an aqueous solution 2 and a sample of a fibrous product 1 immersed therein, the sample having initial dry weight mᵢ;
optionally a unit 4 configured to subject the immersed sample(s) to mechanical energy for promoting disintegration of the sample(s) into fragments;
a first screen 6 configured to fractionate the aqueous solution containing the disintegrated sample of the fibrous product 5 to a permeate 7 containing a passed fraction of the disintegrated sample, and to a retained fraction 8 of the disintegrated sample on the first screen; and
at least one analysis unit 11 configured to subject the permeate 7 containing the passed fraction of the disintegrated sample to an analysis of at least one parameter for obtaining at least one characterizing value, and/or
units for gravimetric analysis comprising:
a filtration unit 12 comprising a filtration device having dry weight m₁ configured to separate the permeate 7 to a filtrate 13 and to the passed fraction of the disintegrated sample on the filtration device 14,
a drying unit 9 configured to dry representative sample(s), the filtration device, and the passed fraction of the disintegrated sample on the filtration device 14, and a weighing unit 10 configured to weigh the dried representative samples(s) to obtain mᵢ, the dried filtration device to obtain m₁ and the dried passed fraction of the disintegrated sample on the filtration device to obtain m₂, and
a processing unit 15 for obtaining a disintegration-% of the fibrous product by calculating with equation:

$$Disintegration - \% = \frac{( {m}_{2} - {m}_{1} )}{{m}_{i}} ⋆ 100 \% ,$$

and optionally for normalizing the disintegration-% by dividing by a basis weight, caliper, bulk, or density of the fibrous product, or by the initial sample dry weight mᵢ.

In some embodiments, unit 4 is a device for static mixing or ultrasonication, preferably a device for static mixing.

In some embodiments, the device for static mixing is configured to generate a rotating and/or oscillating movement, and comprises clamp(s) for mounting the receptacle(s).

In some embodiments, the device for static mixing is an oscillating plane or a rotating mixer.

The filtration device may be any filtration device designed for such a purpose such as a filter paper, forming a filtration unit together with e.g. Buchner funnel and vacuum flask. The filtration device collects the passed fraction of the disintegrated sample from step (c) of the methods.

In some embodiments, at least one analysis unit 11 is configured for optical analysis, such as a turbidimeter, a nephelometer, a ratio turbidimeter, a photometer, an ultraviolet-visible spectrophotometer, a laser-based turbidimeter, a reflectometer, a fiber-optic system, or an optical backscatter sensor (OBS), preferably a ratio turbidimeter. Preferably the system comprises both at least one analysis unit 11 and the units for gravimetric analysis, thereby providing more information on the disintegration of the fibrous product.

A typical process for manufacturing a fibrous sheet exhibiting controlled disintegration, such as a flushable or repulpable fibrous sheet, comprises: providing an aqueous suspension comprising cellulosic fibers, non-cellulosic polymeric fibers, or any combinations thereof; draining the aqueous suspension to form a wet fibrous web, and drying the wet fibrous web to obtain a fibrous sheet; wherein at least one chemical additive contributing to wet strength of the fibrous sheet is incorporated to the aqueous suspension or added on the wet fibrous web or on the dried fibrous sheet; measuring disintegration of the fibrous sheet according to a method of the invention for obtaining a characterizing value for the fibrous sheet; comparing the obtained value and a predetermined value; and adjusting the incorporation or addition of the at least one chemical additive based on the difference between the obtained value and the predetermined value.

The measurement may be conducted once, or several times during the manufacturing process of the fibrous sheet, regularly or occasionally, e.g. as quality control. The process for manufacturing the fibrous sheet exhibiting controlled disintegration may benefit especially from a method for measuring disintegration that uses a quick analysis, such as an optical analysis.

The chemical additive may be any chemical additive that has contribution, either alone or in combination with other chemical additives, to wet strength of the fibrous sheet. Examples of a chemical additive contributing to wet strength of the fibrous sheet include a wet strength agent, such as a permanent wet strength agent or a temporary wet strength agent, a degradation agent, a wet strength decay enhancing agent, or a dry strength agent.

By the predetermined (reference) value it is meant e.g. a disintegration-% or a turbidity value that is expected to correlate with desired level of dispersibility or flushability or repulpability for e.g. a certain type of a fibrous product. Such predetermined value may be determined for example by creating a calibration curve.

The difference between the obtained value and the predetermined value may trigger for example reducing a wet strength agent dosage if the detected value did not reach the predetermined value correlating with dispersibility, or increasing a wet strength agent dosage if the detected value indicated very high dispersibility potential, so that the strength level that is needed for the intended use is not compromised.

The present invention further relates to a fibrous sheet exhibiting controlled disintegration, such as a flushable or repulpable fibrous sheet, obtainable by the process according to one or more embodiments of the present invention.

The embodiments of the present invention or any particular features or characteristics described in this specification may be combined, in whole or in part, with each other. Even several of the embodiments or particular features or characteristics may be combined, in whole or in part, together to form a further embodiment of the present invention. Such modifications and variations are intended to be included within the scope of the present invention. A method, a system, a process or a fibrous sheet, to which the present invention is related, may comprise at least one of the embodiments of the present invention described in this specification.

In the following, some embodiments of the present invention will be described in more detail with reference to the accompanying figure. The invention below discloses some embodiments and examples of the present invention in such detail that a person skilled in the art is able to utilize the present invention. Not all steps of the embodiments are discussed in detail, as many of the steps will be obvious for the person skilled in the art based on this specification.

### EXAMPLES

These embodiments of disintegration measurement method for fibrous products were developed to quantitatively evaluate the rate of disintegration of fibrous products such as tissue or towel under ambient conditions and minimal shear. The method is designed to address the initial disintegration of the fibrous product under low shear and low residence time and also disintegration of fibrous product using longer residence time and higher shear values. The equipment used is all portable, allowing for in-lab or in-field use. The method is suitable for measuring both the liberation of free fiber and fines as well as macro-scale disintegration or break up of the sheet into smaller fragments and fiber bundles.

### Example 1

### Equipment

Horizontal mixing wheel
Programmable orbital shaker
200 ml glass jars
Analytical balance with accuracy of 0.001 g
Lab oven, heated to 105° C.
Aluminum weighing pans
Cutting table or scissors
Dynamic drainage jar (digital output preferred), DDJ, with a coarse back-up screen having mesh size of about 1/16″
Collection vessel
4 L vacuum flask with 150 mm diameter Buchner funnel
Whatman #4 qualitative filter paper, 150 mm dia., Cat. No. 1004150
Hach 2100P turbidity meter, Model 2100P. This model operates on the nephelometric principle of turbidity measurement. The optical system includes a tungsten-filament lamp, a 90° detector to monitor scattered light and a transmitted light detector. The instrument's microprocessor calculates the ratio of the signals from the 90° and transmitted light detectors. This ratio technique corrects for interferences from color and/or light absorbing materials (such as activated carbon) and compensates for fluctuations in lamp intensity, providing long-term calibration stability. The optical design also minimizes stray light, increasing measurement accuracy.
600 ml beakers (2)

### Sample Preparation

Tissue or towel samples were run in triplicate and average values were reported for each sample. In case of a multi-ply sample, plies were not separated prior to testing.

Tissue samples were separated at the perforated ply and lightly stacked on top of each other. Four tissue squares were used for each test. All four edges of the tissue were trimmed to give a center square that is 3″ by 3″. The stacked pieces of tissue were cut into 1″ by 1″ pieces. Representative tissue squares were dried in an oven for one hour, 105° C. and the tissue weight was recorded as “initial dry weight”, mᵢ, that was used for all samples of same product and same size.

### Equipment Preparation

### Setting Up the Mixing Wheel:

The horizontal mixing wheel was plugged in. The rotating arm of the unit was angled so that when the clamps were filled with jars, it remained in place and did not fall forward. The control system of the mixing wheel reads in % output, not RPM. Using a stopwatch, count the revolutions per minute to determine the % output necessary to achieve 35 RPM. The dynamic drainage jar (DDJ) system was plugged in and placed near a sink and water source. The fine screen was removed from the DDJ vessel, leaving only the coarse back-up screen and two O-rings installed. The digital speed reading was set at 100 RPM and the impeller was set at about 0.5 cm from the screen. The oven was set at 105° C.

### Setting Up the Orbital Shaker:

The shaker table was plugged in and unit turned on. RPM output and timer were set to desired setting. The built in heater of the shaker table was turned off.

### Disintegration Method

1. The tissue squares having representative initial dry weight were placed into a clean glass jar.
2. A 200 ml volume of deionized water was carefully poured over the tissue sample and the jar was capped before for testing.
3. After all samples were prepared, they were placed into the mixing apparatus (either the horizontal mixing wheel or the orbital shaker). The equipment was set to the time and mixing/speed conditions listed in Table 1.
4. After mix time was complete, the mixing unit was turned off and all jars removed.
5. Samples were screened through the DDJ in a manner similar to the fines fractionation test (Tappi Fines Fraction procedure). The contents of the jar were poured into the plugged DDJ vessel. The jar was then rinsed with 400 ml of clean tap water, in two additions, and that rinse water was added to the DDJ vessel.
6. The DDJ vessel was placed into the stand and the impeller was turned on for one minute. The purpose of this mixing was to distribute the fines, not to shear the tissue fiber.
7. A large collection vessel was placed beneath the DDJ apparatus.
8. After one minute, the plug at the base of the jar was removed and the free contents of the vessel were rinsed through into the collection vessel.
9. A portion of this liquid in the collection vessel was analyzed for turbidity immediately using Hach Turbidity meter 2100P. The turbidity meter was calibrated with Hach calibration standards and zeroed with the source of deionized water used for the aqueous phase of testing prior to use.
10. The plug was reinstalled in the DDJ vessel and four more 600 ml aliquots of clean water were rinsed through at 15 second intervals. The purpose of these rinse cycles were to fully rinse the fines from the tissue samples.
11. After all rinses were performed, the DDJ vessel was disassembled. An O.D. pre-weighed filter paper was placed in the Buchner funnel and then the content of the collection vessel was filtered on the vacuum flask.
12. The filter paper pad was dried for 1 hour and the O.D. weight (m₂) recorded.
13. The total disintegration or free fiber and fines were each calculated as follows:

$$Disintegration - \% = \frac{( {m}_{2} - {m}_{1} )}{{m}_{i}} ⋆ 100 \% .$$

TABLE 1
Static mixing parameters

| | Mixing Wheel | Shaker Table |
|---|---|---|
| Tissue | 26 rpm, 30 min | 75 rpm, 30 min |
| Towel | 69 rpm, 3 hrs* | 400 rpm, 30 min |

TABLE 2
Brief description of samples

| | |
|---|---|
| S1 | 32 gsm multifold wash room hand |
| | towel |
| S2 | 2-ply bath tissue |
| S3 | 2-ply bath tissue |
| S4 | 2-ply bath tissue 2 |
| S5 | 2 ply bath tissue |
| S6 | OCC wash room hand towel roll |
| S7 | OCC wash room hand towel roll |
| S8 | wash room hand towel |
| S9 | 2 ply bath tissue |

### Results:

This example used a 1/16″ screen so the test measured yield of free fiber and fines fraction, and not macro-scale disintegration.

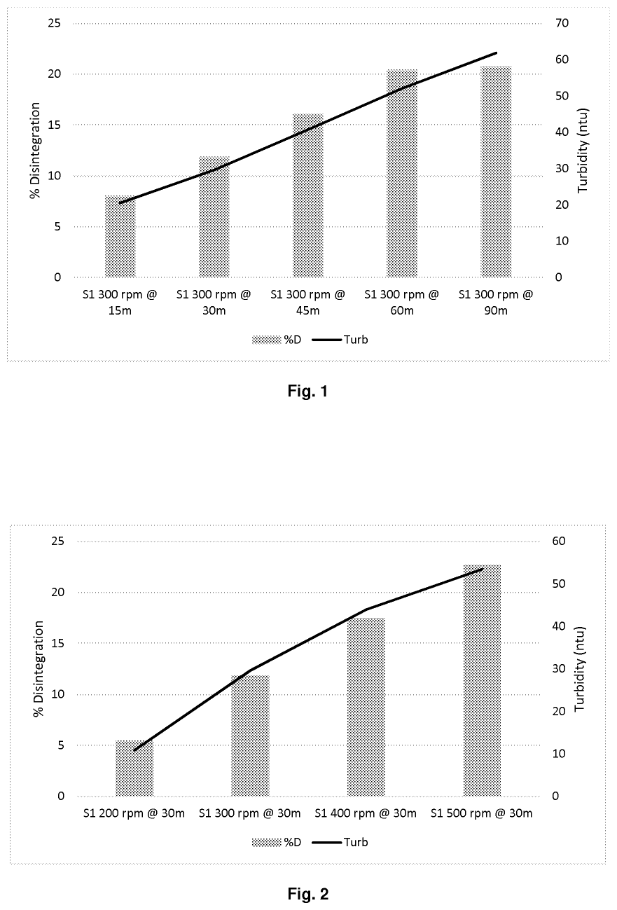

The rate of disintegration for towel is shown to correlate well to both residence time and speed, as seen in FIGS. 1 and 2 respectively. Testing parameters of 400 rpm and 30 minutes agitation time were selected for testing from these results in an effort to give a quick and accurate measurement of rate of disintegration.

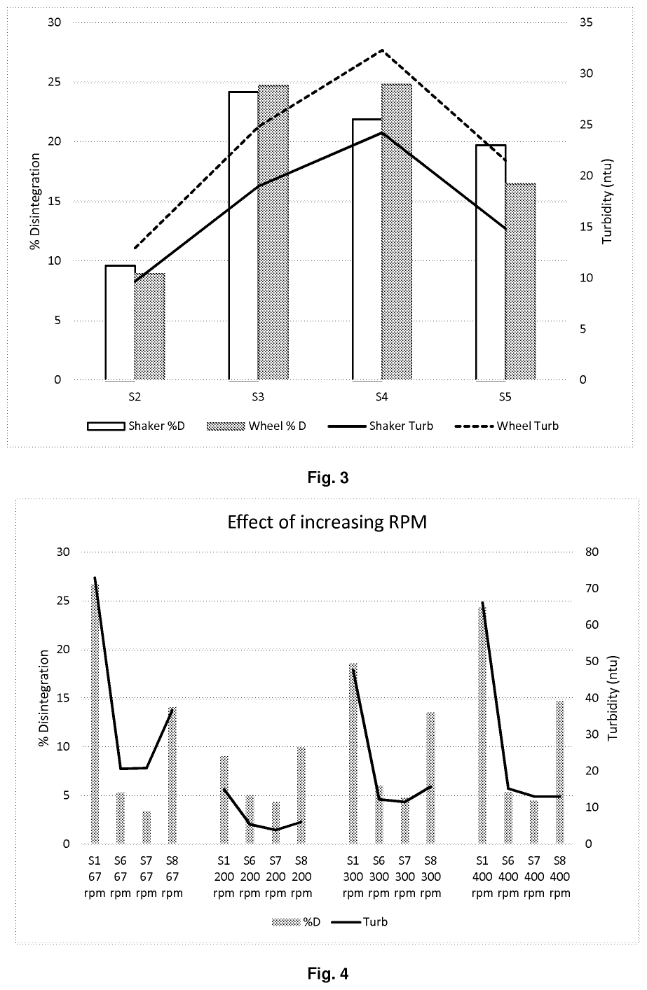

For tissue samples, testing parameters of 150 rpm and 30 minutes were selected for the shaker table. An agitation speed of 150 rpm was necessary to give a gentle agitation that would provide adequate shear inside of the receptacle. For the vertical mixing wheel, conditions are 26 rpm and 30 minutes. FIG. 3 shows a comparison of % disintegration and turbidity results for four tissue samples tested by both the shaker table and the horizontal mixing wheel. Results are very similar.

FIG. 4 shows the comparison of results achieved on towel testing with the vertical mixing wheel (far left, 67 rpm) and the shaker table (200, 300 and 400 rpm). The mechanical energy was applied for 30 min, except for the shaker table test using highest speed (400 rpm). Results are similar between the mixing wheel and the highest speed (400 rpm) tested on the shaker table. Turbidity tracks closer to real disintegration-% in the shaker table results than with the mixing wheel.

### Example 2

### Equipment

Horizontally to vertically adjustable wheel mixer set at 45 degree angle
(4) 200 ml glass jars with lids, (8) when free fiber and fines will also be quantified
Analytical balance with accuracy of 0.001 g
Lab oven, heated to 105° C.
Aluminum weighing pans
Cutting table or scissors
Dynamic drainage jar (DDJ also known as a Britt jar) modified with a ⅜″ inside diameter drain tube within the standard drain stopper plug. The DDJ impeller itself may be used when desired. A 4.125″ diameter DDJ screen with ½″ diameter perforated holes and 11/16″ stagger. Optionally, a 1/16″ diameter perforated screen with 7/64″ stagger for free fiber and fines quantification.
4 L collection beaker
4 L vacuum flask with 150 mm diameter Buchner funnel
Whatman #4 qualitative filter paper, 150 mm dia., Cat. No. 1004150
250 ml & 1000 ml volumetric cylinders
1 L beakers (4)
500 ml squeeze bottle with tap water

### Sample Preparation

Prepare four or eight test samples total, one test sample for each of four different time periods to generate a disintegration profile versus time curve and optionally, one parallel test sample for each of the same four time periods to generate a free fiber and fines versus time curve. Times should be selected based on “anticipated results”. For example, a 4 point curve at 15, 30, 60, and 90 minutes is recommended for a product anticipated to have a high rate of disintegration; 1, 2, 4, and 6 hours for a product having a moderate rate of disintegration, and 24, 48, 72 & 96 hours for a product expected to have a low rate of disintegration. Test times can also be reduced as needed by increasing the wheel mixer RPMs (26 RPMs is the standard setting for this method). If the sample is multi-ply, plies should not be separated prior to testing.

If perforated, tissue or towel samples are separated at the perforation and then cut or cut directly from an unperforated roll or sheet into 3″×3″ squares. Representative tissue squares were dried in an oven for one hour, 105° C. and the tissue weight was recorded as “initial dry weight”, mᵢ, that was used for all samples of same product and same size.

Several squares to approximately 0.5 g total of the 3″×3″ pieces are used for each test. Weigh and record the weight of the test pieces using an analytical balance (mᵢ). A minimum of 4 or 8 test samples are needed (2.00 g or 4.00 g minimum total O.D. weight in 3″×3″ pieces). Record and mark the representative weight of each test sample on the associated sample jar to be used for each test sample.

### Equipment Preparation

### Setting Up the Wheel Mixer and DDJ:

Plug in the wheel mixer and ensure that the cords are out of the way. The rotating arm of the unit should be angled at 45 degrees so that when the clamps are filled with jars, it remains in place and does not fall forward. There is a small open space at the base of the unit where weights can also be placed to keep the unit from pitching forward.

The control system of the mixing wheel reads in % output, not RPM. Using a stopwatch, count the revolutions per minute to determine the % output necessary to achieve 26 RPM. For products that have very slow disintegration (i.e. high wet-strength), mixer speed can be increased to decrease test times. The maximum speed for this model mixer is around at most 70 RPM.

The dynamic drainage jar (DDJ) system should be placed near a sink and tap water source.

Place the screen with the ½″ diameter perforated holes for testing and quantifying macro-disintegration or the screen with 1/16″ diameter perforated holes for quantifying free fiber and fines in the DDJ vessel between the two O-rings.

The oven should be set at 105 degrees C.

Also oven dry at least 4 pieces of Whatman filter paper for one hour, one piece for each tissue test sample, for gravimetric quantification of disintegration. Oven dry 8 pieces total if free fiber and fines will also be quantified. Measure and record O.D. weight on each piece (m₁).

### Disintegration Method

1. tissue squares having representative initial dry weight (mᵢ) are placed into a clean 200 ml glass jar.
2. A 150 ml volume of tap water is carefully poured over the tissue sample and the jar is capped and ready for testing.
3. After all samples are prepared, they are well clamped into the mixing apparatus or set aside to soak.
4. After each mix time or soak time is completed, turn the mixing unit off and remove the jar or take one of the jars that has been soaking. Turn the mixer back on for the other subsequent samples in the time study.
5. Samples are screened through the DDJ in a manner similar to the fines fractionation test (Tappi Fines Fraction procedure). The DDJ vessel is placed into the stand. The 4 L collection vessel is placed beneath the DDJ apparatus. Adjust the height of the DDJ holder as needed.
6. The contents of the jar is rinsed out and diluted with 600 ml into a 1 L beaker. The 1 L beaker is then poured into the plugged DDJ vessel.
7. After about 5 seconds, the drain clamp at the base of the jar is removed and the disintegrated contents of the vessel are rinsed through into the collection vessel.
8. The drain clamp is reinstalled in the DDJ vessel and three additional 750 ml aliquots of tap-water are added and rinsed through after allowing 5 seconds of mixing. Pour each aliquot down the opposite wall to avoid pouring directly on the tissue paper. Doing so also creates vertical clockwise mixing that re-suspends the tissue sample throughout the DDJ. The purpose of these rinse cycles is to fully rinse loose fibers, fines, fiber bundles, and small tissue paper fragments from any larger remaining tissue pieces through the screen. Note for a free fiber and fines test: Though not expected based on the tests run to validate this method, if high free fiber levels (above 50% or so) are encountered, more rinse cycles may be required. The degree of wash through can be noted during each drain cycle to see how much loose material collects over the 1/16″ diameter perforated screen as the tap water drains. Adjust the number of rinse cycles used for this test accordingly as necessary.
9. After all rinses have been performed, the DDJ vessel is disassembled. The fiber remaining in the jar above the screen is discarded and washed clean for the next test. Any fibers and fiber bundles remaining in the base of the DDJ below the screen or in the DDJ plug and drain tube should be rinsed into the 4 L collection vessel. A squeeze bottle containing tap water can be used for this purpose.
10. Rinse clean and reassemble the DDJ vessel and drain plug.
11. Place an O.D. pre-weighed filter paper in the Buchner funnel and then filter the content of the 4 L collection vessel on the vacuum flask.
12. Oven-dry the filter paper pad for 1 hour and record the O.D. weight (m₂).
13. Optionally, if the free fiber and fines fraction is to be quantified, reassemble the DDJ vessel in step 11 with the 1/16″ diameter perforated screen and repeat steps 5-12 for the second sample.
14. The total disintegration or free fiber and fines are each calculated as follows:

$$Disintegration - \% = \frac{( {m}_{2} - {m}_{1} )}{{m}_{i}} ⋆ 100 \% .$$

### Results:

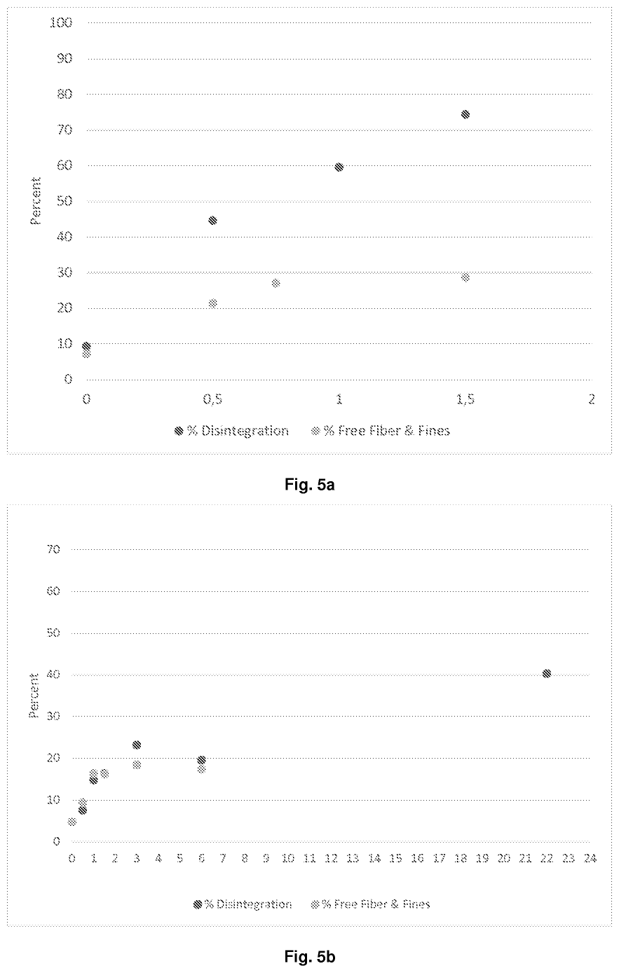

FIGS. 5a & b show disintegration-% as function of time (h) for 2-ply bath tissues (FIG. 5a S3; FIG. 5b S2) using 26 rpm on mixer wheel, and Britt jar at 100 rpm while screening through a ¼″ screen vs 1/16″ screen. These figures show the difference in total disintegration (¼″) over time versus free fiber and fines disintegration ( 1/16″). For the product tested in 5a total disintegration, i.e. including macro-scale disintegration, continues with time while free fiber and fines liberation plateaus at around 30%. For the product tested in 5b disintregration proceeds primarily as liberated free fibers and fines with very little macro-scale disintegration.

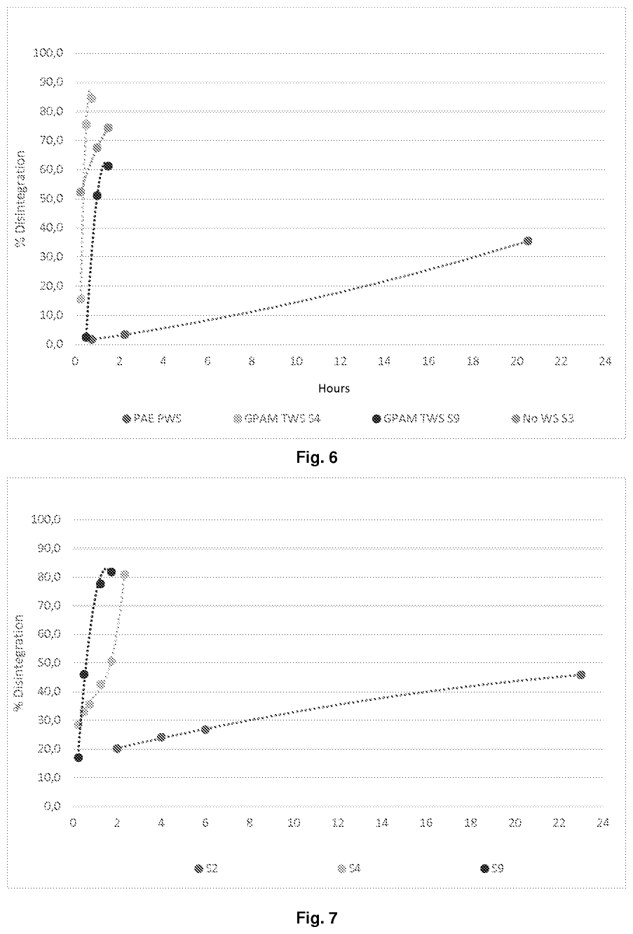

FIG. 6 shows disintegration-% as function of time (h) for four 2-ply bath tissues using 26 rpm on mixer wheel, and no mixing while screening through a ½″ screen. Effect of permanent or temporary or no wet strength agent on disintegration rate is demonstrated.

FIG. 7 shows disintegration-% as function of time (h) for three 2-ply tissues using rpm on mixer wheel, and no mixing while screening through a ¼″ screen, so testing using higher rpms but smaller screen size, ¼″, compared to FIG. 6. Disintegration rates can be increased and test times can be reduced significantly by utilization of higher rpm mixing (i.e. higher energy input).

It is obvious to a person skilled in the art that with the advancement of technology, the basic idea of the present invention may be implemented in various ways. The present invention and its embodiments are thus not limited to the examples described above, instead they may vary within the scope of the claims.

1. A method for measuring a disintegration of a fibrous product, comprising:
(a) immersing at least one sample of a fibrous product in an excess of an aqueous solution in a receptacle, at a time point t₀ for initiating the disintegration of a sample(s), the sample having an initial dry weight mᵢ;
(b) optionally subjecting the immersed sample(s) to a mechanical energy for promoting the disintegration of the sample(s) into disintegrated sample(s);
(c) passing the aqueous solution containing a first disintegrated sample of the fibrous product after a first time period at a time point t₁ through a first screen to obtain a permeate containing a passed fraction of the disintegrated sample, and a retained fraction of the disintegrated sample on the first screen, and optionally continuing immersion of any further immersed sample(s); and
(d) subjecting the permeate containing the passed fraction of the disintegrated sample from step (c) to an analysis of at least one parameter for obtaining at least one characterizing value.

2. The method of claim 1, wherein the obtained at least one characterizing value is compared to a predetermined reference value thereby determining difference between the obtained at least one characterizing value and the predetermined reference value.

3. The method of claim 1, wherein the analysis of the at least one parameter comprises a gravimetric analysis, an optical analysis, an electrochemical analysis, a volumetric analysis, or any combination thereof.

4. The method of claim 3, wherein the gravimetric analysis comprises steps of:
(e) filtering the permeate through a filtration device having a dry weight m₁ to obtain a filtrate and the passed fraction of the disintegrated sample on the filtration device;
(f) drying and weighing the filtration device and the passed fraction of the disintegrated sample to obtain a weight m₂, and obtaining a disintegration-% of the fibrous product by calculating with an equation:
$$Disintegration - \% = \frac{( {m}_{2} - {m}_{1} )}{{m}_{i}} ⋆ 100 \% ;$$
and optionally normalizing the disintegration-% by dividing by a basis weight, a caliper, a bulk, or a density of the fibrous product, or by the initial sample dry weight mᵢ.

5. The method of claim 4, wherein at a time point t₂, a second disintegrated sample, and optionally at any further time point tₙ any further disintegrated sample, is subjected to steps (c) to (f), and the obtained disintegration-% values are plotted as a function of time (t₁, t₂ . . . tₙ) to obtain a rate of disintegration for the fibrous product.

6. The method of claim 5, wherein said:
(a) characterizing value to a predetermined reference value or
(b) said rate of disintegration for the fibrous product,
is compared with respective values obtained from other samples or samples obtained using different process parameters.

7. The method of claim 1, wherein in step (b), the mechanical energy is generated by static mixing and/or by ultrasonication, preferably by static mixing.

8. The method of claim 7, wherein the static mixing is conducted by subjecting the sample(s) of the fibrous product immersed in the aqueous solution to a rotating and/or oscillating movement.

9. The method of claim 8, wherein subjecting the sample(s) to a rotating and/or oscillating movement is conducted by mounting the receptacle(s) to a rotating mixer or to an oscillating plane.

10. The method of claim 1, wherein in step (c), the retained fraction of the disintegrated sample on the first screen is rinsed with rinsing water for flushing any entrapped fines through the screen to the permeate.

11. The method of claim 1, wherein in step (c), the first screen has a mesh size of at most ½″, preferably at most ¼″, more preferably at most ⅛″.

12. The method of claim 1, wherein in step (c), passing the aqueous solution containing the first disintegrated sample of the fibrous product through the first screen, is facilitated by mixing.

13. The method of claim 1, further comprising passing for each sample a parallel sample in step (c) through a second screen having a mesh size smaller than the mesh size of the first screen to obtain a parallel permeate containing a passed fraction of the disintegrated parallel sample, and a retained fraction of the disintegrated parallel sample on the second screen, followed by step (d) for obtaining a parallel characterizing value.

14. The method of claim 13, wherein in step (c), the first screen has a mesh size of at most ½″ and the second screen has a mesh size of at most ⅛″.

15. The method of claim 1, wherein the fibrous product is a fibrous sheet, preferably a paper or a nonwoven.

16. A system for measuring a disintegration of a fibrous product, comprising:
at least one receptacle configured to receive an aqueous solution and a sample of a fibrous product immersed therein, the sample having an initial dry weight mᵢ;
optionally a unit configured to subject the immersed sample(s) to a mechanical energy for promoting disintegration of the sample(s) into fragments;
a first screen configured to fractionate the aqueous solution containing the disintegrated sample of the fibrous product to a permeate containing a passed fraction of the disintegrated sample, and to a retained fraction of the disintegrated sample on the first screen; and
at least one analysis unit configured to subject the permeate containing the passed fraction of the disintegrated sample to an analysis of at least one parameter for obtaining at least one characterizing value, and/or
units for gravimetric analysis comprising:
a filtration unit comprising a filtration device having a dry weight m₁ configured to separate the permeate to a filtrate and to the passed fraction of the disintegrated sample on the filtration device;
a drying unit configured to dry representative sample(s), the filtration device, and the passed fraction of the disintegrated sample on the filtration device, and a weighing unit configured to weigh the dried representative samples(s) to obtain mᵢ, the dried filtration device to obtain m₁ and the dried passed fraction of the disintegrated sample on the filtration device to obtain m₂; and
a processing unit for obtaining a disintegration-% of the fibrous product by calculating with an equation:
$$Disintegration - \% = \frac{( {m}_{2} - {m}_{1} )}{{m}_{i}} ⋆ 100 \% ;$$
and optionally for normalizing the disintegration-% by dividing by a basis weight, caliper, bulk, or density of the fibrous product, or by the initial sample dry weight mᵢ.

17. A process for manufacturing a fibrous sheet exhibiting a controlled disintegration comprising:
providing an aqueous suspension comprising cellulosic fibers, non-cellulosic polymeric fibers, or any combinations thereof;
draining the aqueous suspension to form a wet fibrous web, and drying the wet fibrous web to obtain the fibrous sheet;
incorporating at least one chemical additive contributing to a wet strength of the fibrous sheet to the aqueous suspension or adding the at least one chemical additive on the wet fibrous web or on the dried fibrous sheet;
measuring the disintegration of the fibrous sheet according to the method of claim 1 for obtaining a characterizing value for the fibrous sheet;
comparing the obtained value and a predetermined value; and
adjusting the incorporating or the adding of the at least one chemical additive based on a difference between the obtained value and the predetermined value.

18. A fibrous sheet exhibiting a controlled disintegration obtainable by the process of claim 17.
